(19) United States
(12) Patent Application Publication
(10) Pub. No.: US 2007/0009339 A1
(43) Pub. Date: Jan. 11, 2007

(54) Fastener having a plurality of heads

(75) Inventor: Erik Steck Merck, Sharon, MA (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Ambient Corporation

(21) Appl. No.: 11/175,419

(22) Filed: Jul. 6, 2005

(51) Int. Cl. F16B 19/00

(52) U.S. Cl. 411/409

(57) ABSTRACT

There is provided a fastener. The fastener includes (a) a threaded portion, (b) a first head distal to the threaded portion, rotation of which causes rotation of the threaded portion, (c) a second head, rotation of which causes rotation of the threaded portion, and (d) a neck situated between the first head and the second head. The first head and the second head are loop-shaped, and the neck shears when the first head is subjected to a torque.

### BACKGROUND OF THE INVENTION

1. Field of the Invention

The present invention relates to a fastener that includes a threaded portion that mates with another threaded element. The fastener has a plurality of heads for rotating the fastener so that if one head becomes detached, another head is still available. The bolt is particularly suitable for use on a device to be installed on, or removed from, an active power line.

2. Description of the Related Art

An electric utility lineman may be required to install a device on an energized medium voltage power line or high voltage power line. The device includes a fastener for securing the device to the power line. For the installation, the lineman uses gloved hands and a long insulated tool typically termed a “hot stick.” At voltage levels of 15 kilovolts and above, work rules may mandate the use of the hot stick so as to distance the lineman from an energized circuit. The hot stick has a hook that engages the fastener for tightening or loosening the fastener. However, working with heavily gloved hands or a hot stick, an installer may not be able to accurately sense the torque he applies to the fastener when installing the device onto an active power line.

There is a need for a fastener that enables a lineman to install equipment on, or remove equipment from, an active power line, while the lineman is using either protective insulated gloved hands or insulated gloved hands and a hot stick.

### SUMMARY OF THE INVENTION

There is provided a fastener. The fastener includes (a) a threaded portion, (b) a first head distal to the threaded portion, rotation of which causes rotation of the threaded portion, (c) a second head, rotation of which causes rotation of the threaded portion, and (d) a neck situated between the first head and the second head. The first head and the second head are loop-shaped, and the neck shears when the first head is subjected to a torque.

Another embodiment of a fastener includes (a) a threaded portion, (b) a first head distal to the threaded portion, rotation of which causes rotation of the threaded portion, (c) a second head, rotation of which causes rotation of the threaded portion, (d) a third head proximal to the threaded portion, rotation of which causes rotation of the threaded portion, (e) a first neck situated between the first head and the second head, and (f) a second neck situated between the second head and the third head. The first neck shears when the first head is subjected to a first torque, and the second neck shears when the second head is subjected to a second torque.

### BRIEF DESCRIPTION OF THE DRAWINGS

FIG. 1 is a three dimensional view of a fastener having a plurality of heads.

FIG. 2 is a three dimensional view of an inductive coupler on a utility line.

### DESCRIPTION OF THE INVENTION

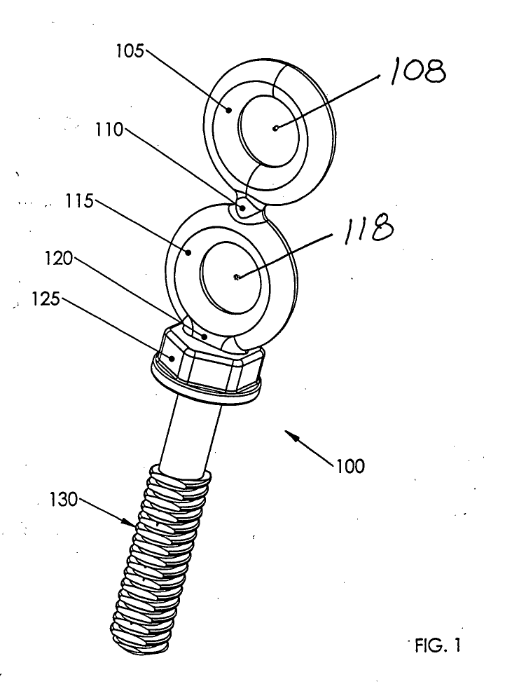

FIG. 1 is an illustration of a three dimensional view of a fastener 100. Fastener 100 includes a head 105, a neck 110, a head 115, a neck 120, a head 125 and a threaded portion 130. Head 105 includes an orifice 108, and head 115 includes an orifice 118. Head 105 is connected to neck 110. Neck 105 is connected to head 115. Head 115 is connected to neck 120. Neck 120 is connected to head 125, and head 125 is connected to threaded portion 130.

Threaded portion 130 has threads on its external surface and mates with an element (not shown) having opposing threads on an internal surface, e.g., a nut. Neck 110 has a cross-sectional area that is less than a cross-sectional area of threaded portion 130, and is designed to shear at a torque that is less than a maximum design torque of threaded portion 130.

A user inserts a hook or other tool (not shown) into orifice 108. Rotating the hook causes head 105 to rotate, which in turn causes fastener 100 to rotate. Thus, threaded portion 130 screws into its mating element.

There are two cases to consider that may occur during an installation of fastener 100 while applying torque to head 105. The first is that the user senses a sudden increase in torque, indicating that fastener 100 is tight. The second is that the user does not sense an increase in torque and continues to apply increasing torque to head 105, causing neck 110 to shear, detaching head 105 from the fastener 100. Since, as mentioned above, neck 110 is designed to shear at a torque that is less than a maximum design torque of threaded portion 130, this shearing of neck 110 prevents excess torque from being applied to both of threaded portion 130 and the element with which threaded portion 130 is mating.

Neck 120 has a cross-sectional area that is greater than the cross-sectional area of neck 110, therefore, neck 120 can withstand a greater torque than can neck 110. Thus, should head 105 be detached from fastener 100, the user can insert a hook into orifice 118, to rotate head 115, to remove fastener 100.

Neck 120 has a cross-sectional area that is less than a cross-sectional area of threaded portion 130, and therefore, threaded portion 130 can withstand a greater torque than can neck 120. If a sufficient torque is applied to head 115, neck 120 will shear. When neck 120 shears, head 115 detaches from fastener 100.

Head 125 remains intact, and serves as a backup in a case where heads 105 and 115 are both detached from fastener 100. Head 125 has a cross-sectional area greater than a cross-sectional area of threaded portion 130, so as to preclude the stripping of head 125 when torque is applied to head 125.

Each of heads 105, 110 and 125 have a shape that accommodates a torque-applying tool, for example, a wrench or a hook. While in FIG. 1 heads 105 and 115 are illustrated as being closed loops, i.e., closed contours, and head 125 is illustrated as having a hexagonal shape, any of heads 105, 115 and 125 can be either loop-shaped or hex-shaped. They can have other shapes, such as a hook-shape or a “T” -shape. Heads 105, 115 and 125 may have open contours having a gap, i.e., an opening, forming a “C”-shape for example, so as to facilitate use of a closed loop tool. Heads 105, 115 and 125 can all have the same shape, or they can be shaped differently from one another.

While threaded portion 130 is shown herein as having threads on its external surface, an alternative implementation is for an internal threaded element, similar to that of a nut. Optionally, if threaded portion 130 has internal threads, its outer surface may be hexagonal or other non-cylindrical shape, so as to serve as a head.

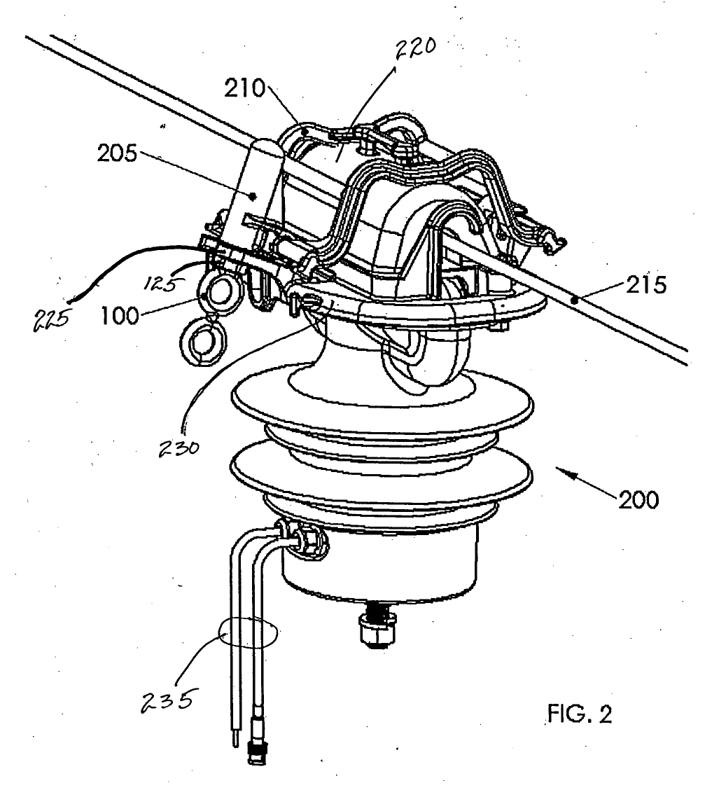

FIG. 2 is a three dimensional view of an inductive coupler 200 situated on a power line 215. Inductive coupler 200 couples a data signal between power line 215 and a communication device such as a modem (not shown) via cables 235. Internally to inductive coupler 200, and therefore not represented in FIG. 2, inductive coupler 200 includes a magnetic core, and a wire wound around a portion of the magnetic core. The magnetic core is configured of “C”-shaped portions that, when placed adjacent to one another, form an “O” and therefore provide an aperture. Power line 215 is routed through the aperture in the magnetic core.

Inductive coupler 200 operates as a transformer, where power line 215 serves as a first winding of the transformer, and the wire wound around a portion of the magnetic core serves as a second winding of the transformer. The wire wound around a portion of the magnetic core is coupled to cables 235. Inductive coupler 200 includes fastener 100, a pivot nut 205, a cover 220, a base 230, and a bracket fastener 210.

Cover 220 is sandwiched between bracket fastener 210 and base 230. On the right side of FIG. 2, e.g., the rear side of inductive coupler 200, bracket fastener 210 is pivotally fastened to base 230. On the left side of FIG. 2, e.g., the front side of inductive coupler 200, pivot nut 205 is mechanically fastened to bracket fastener 210.

Base 230 includes a shoulder 225. Head 125 is situated against shoulder 225 so that as fastener 100 is screwed into pivot nut 205, bracket fastener 210 is pulled toward cover 220, and cover 220 is drawn closer to base 230. That is, as fastener 100 is tightened into pivot nut 205, bracket fastener 210 acts as a lever to bring cover 220 and base 230 together. In effect, fastener 100 is being utilized as an actuator to open or close inductive coupler 200, which in turn, separates the core portions (within inductive coupler 200), or locks the core portions together around power line 215.

During installation of inductive coupler 200 onto power line 215, or during removal of inductive coupler 200 from power line 215, a lineman can utilize a hot stick or other suitable tool to rotate head 105 and/or head 115 and/or head 125 (see FIG. 1). Thus, the lineman can remove or install inductive coupler 200 while line 215 is energized.

Note that if both of heads 105 and 115 are loop shaped, the lineman can access them with a hot stick. If head 105 becomes detached, the lineman can use the hot stick to rotate head 115, and thus rotate fastener 100 in order to remove inductive coupler 200 from power line 215. As such, the lineman does not need to fall back on head 125, and so, fastener 100 need not include neck 120 and head 125.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A fastener, comprising:
a threaded portion;
a first head distal to said threaded portion, rotation of which causes rotation of said threaded portion;
a second head, rotation of which causes rotation of said threaded portion; and a neck situated between said first head and said second head;
wherein said first head and said second head are loop-shaped, and
wherein said neck shears when said first head is subjected to a torque.

2. A fastener, comprising:
a threaded portion;
a first head distal to said threaded portion, rotation of which causes rotation of said threaded portion;
a second head, rotation of which causes rotation of said threaded portion;
a third head proximal to said threaded portion, rotation of which causes rotation of said threaded portion;
a first neck situated between said first head and said second head; and
a second neck situated between said second head and said third head,
wherein said first neck shears when said first head is subjected to a first torque, and
wherein said second neck shears when said second head is subjected to a second torque.

3. The fastener of claim 2, wherein said first neck has a cross-sectional area that is less than a cross-sectional area of said threaded portion.

4. The fastener of claim 2, wherein said second neck has a cross-sectional area that is greater than a cross-sectional area of said first neck.

5. The fastener of claim 2, wherein said second neck has a cross-sectional area that is less than a cross-sectional area of said threaded portion.

6. The fastener of claim 2, wherein said third head has a cross-sectional area that is greater than a cross-sectional area of said threaded portion.

7. The fastener of claim 2, wherein said first head detaches from said fastener when said first neck shears.

8. The fastener of claim 2, wherein said second head detaches from said fastener when said second neck shears.

9. The fastener of claim 2, wherein said third head remains intact when said first and second necks shear.

10. The fastener of claim 2, wherein said second torque is greater than said first torque.

11. The fastener of claim 2, wherein at least two of said first head, said second head and said third head are loop-shaped.

12. The fastener of claim 2, wherein at least two of said first head, said second head and said third head accommodate a hot stick.

13. An inductive coupler, comprising
a cover;
a base; and
a fastener that is rotated to draw said cover and said base together,
wherein said cover and said base, when situated adjacent to one another, provide an aperture to accommodate a power line, and
wherein said fastener includes:
a threaded portion;
a first head distal to said threaded portion, rotation of which causes rotation of said threaded portion;
a second head, rotation of which causes rotation of said threaded portion;
a third head proximal to said threaded portion, rotation of which causes rotation of said threaded portion;
a first neck situated between said first head and said second head; and
a second neck situated between said second head and said third head,
wherein said first neck shears when said first head is subjected to a first torque, and
wherein said second neck shears when said second head is subjected to a second torque.

14. The inductive coupler of claim 13, wherein said first neck has a cross-sectional area that is less than a cross-sectional area of said threaded portion.

15. The inductive coupler of claim 13, wherein said second neck has a cross-sectional area that is greater than a cross-sectional area of said first neck.

16. The inductive coupler of claim 13, wherein said second neck has a cross-sectional area that is less than a cross-sectional area of said threaded portion.

17. The inductive coupler of claim 13, wherein said third head has a cross-sectional area that is greater than a cross-sectional area of said threaded portion.

18. The inductive coupler of claim 13, wherein said first head detaches from said fastener when said first neck shears.

19. The inductive coupler of claim 13, wherein said second head detaches from said fastener when said second neck shears.

20. The inductive coupler of claim 13, wherein said third head remains intact when said first and second necks shear.

21. The inductive coupler of claim 13, wherein said second torque is greater than said first torque.

22. The inductive coupler of claim 13, wherein at least two of said first head, said second head and said third head are loop-shaped.

23. The inductive coupler of claim 13, wherein at least two of said first head, said second head and said third head accommodate a hot stick.
